(19) United States
(12) Patent Application Publication
(10) Pub. No.: US 2025/0196666 A1
(43) Pub. Date: Jun. 19, 2025

(54) ELECTRIC VEHICLE STRUCTURE

(71) Applicants: Hyundai Motor Company, Seoul (KR); Kia Corporation, Seoul (KR)

(72) Inventor: Ji Ho Choi, Hwaseong-si (KR)

(21) Appl. No.: 18/609,847

(22) Filed: Mar. 19, 2024

(30) Foreign Application Priority Data
Dec. 18, 2023 (KR) 10-2023-0184667

(51) Int. Cl. B60L 50/60; B62D 25/20

(52) U.S. Cl. CPC B60L 50/66; B62D 25/2036

(57) ABSTRACT

An embodiment electric vehicle structure includes a vehicle body, a battery pack mounted at a lower side of the vehicle body, and a battery frame interposed between the vehicle body and the battery pack and configured to protect a front side, a rear side, and two opposite lateral sides of the battery pack.

### CROSS-REFERENCE TO RELATED APPLICATIONS

This application claims the benefit of Korean Patent Application No. 10-2023-0184667, filed on Dec. 18, 2023, which application is hereby incorporated herein by reference.

### TECHNICAL FIELD

The present invention relates to a technology related to a structure of an electric vehicle.

### BACKGROUND

An electric vehicle is configured to generate driving power for a vehicle by operating an electric motor and is equipped with a battery pack for operating the electric motor.

The battery pack has a plurality of battery modules accommodated in a battery casing, and the battery module has a structure in which a plurality of battery cells is stacked.

A traveling distance of the vehicle increases as the number of battery modules or battery cells mounted in the battery pack increases. The battery module or battery cell (hereinafter, collectively referred to as a ‘battery module’) needs to be appropriately protected so that the battery module is not damaged by an impact from the outside.

Therefore, there is an internal technical need for the battery pack mounted in the vehicle that is able to be equipped with as many battery modules as possible, and there is an external technical need for the battery pack that may effectively protect the battery module accommodated therein by using a robust protection structure.

There are efforts to meet the technical needs for protecting the battery module of the battery pack not only by improving the structure or rigidity of the battery pack but also by improving the structure or rigidity of the vehicle.

The foregoing explained as the background of embodiments of the invention is intended merely to aid in the understanding of the background of embodiments of the present invention and is not intended to mean that this information falls within the purview of the related art that is known to the public.

### SUMMARY

The present invention relates to a technology related to a structure of an electric vehicle. Particular embodiments relate to a structure of an electric vehicle in which a battery pack is mounted at a lower side of a vehicle body.

Embodiments of the present invention can solve problems in the art and provide an electric vehicle structure capable of more effectively protecting a battery pack from an external impact caused by a collision accident or the like of a vehicle in the vehicle in which the battery pack is mounted at a lower side of a vehicle body.

An embodiment of the present invention provides an electric vehicle structure including a vehicle body, a battery pack mounted at a lower side of the vehicle body, and a battery frame interposed between the vehicle body and the battery pack and configured to protect a front side, a rear side, and two opposite lateral sides of the battery pack.

The battery frame may be provided in the form of a lattice made by coupling a plurality of longitudinal members and a plurality of transverse members.

The vehicle body may include a floor panel, vehicle body side members provided at two opposite sides of the vehicle body, elongated in a longitudinal direction of the vehicle body, and coupled to a lower surface of the floor panel, vehicle body cross members configured to connect the vehicle body side members at the two opposite sides, elongated in a transverse direction of the vehicle body, and coupled to the lower surface of the floor panel, and side sills disposed below the floor panel and provided at the two opposite ends of the vehicle body.

Two opposite ends of the transverse member of the battery frame may protrude further outward based on the vehicle body than a battery module accommodated in the battery pack and may be positioned adjacent to the side sills, and the longitudinal members of the battery frame may be configured to connect the transverse members in the longitudinal direction at positions adjacent to the side sills.

The plurality of longitudinal members of the battery frame may be positioned outward of the battery module in the battery pack based on the vehicle body and connects the transverse members in the longitudinal direction.

A leaf spring-type suspension system may be provided at a rear side of the vehicle body, and a rear extension part may be provided at a rear side of the battery frame and extend to a front end of a leaf spring mounting bracket.

The rear extension part may be provided at a rear side of the longitudinal member of the battery frame and elongated in a forward/rearward direction so as to define a straight line together with the longitudinal member.

A front extension part may be provided at a front side of the battery frame and protrude forward to support a rear side of a sub-frame disposed at a front side of a vehicle.

The transverse member of the battery frame may be installed to overlap the vehicle body cross member in an upward/downward direction, and a plurality of through pipes may be provided in the transverse member so that frame mounting bolts, which penetrate the transverse member, pass through the through pipes.

The through pipes may include the through pipe positioned below the vehicle body side member and the through pipe positioned outward of the battery module of the battery pack based on the vehicle body.

A plurality of mounting nuts may be provided in the transverse member of the battery frame, and battery mounting bolts for mounting the battery pack may be fastened to the mounting nuts.

A sliding rail part may be provided on the side sill and may be configured to guide a sliding door, and a strength reinforcement part including a reinforcing material may be provided at a lower side of the sliding rail part.

According to embodiments of the present invention, it is possible to more effectively protect the battery pack from an external impact caused by a collision accident or the like of the vehicle in the vehicle in which the battery pack is mounted at the lower side of the vehicle body.

### BRIEF DESCRIPTION OF THE DRAWINGS

FIG. 1 is a view illustrating an electric vehicle structure according to embodiments of the present invention.

FIG. 2 is a view illustrating a state in which a vehicle body, a battery frame, and a battery pack in FIG. 1 are disassembled.

FIG. 3 is a cross-sectional view taken along line III in FIG. 1 for explaining a configuration in which a battery module is mounted on the battery frame by a battery mounting bolt.

FIG. 4 is a view for explaining a state in which the battery module in FIG. 3 is excluded and the battery frame is mounted on the vehicle body by a frame mounting bolt.

FIG. 5 is a view illustrating a state in which the vehicle body in FIG. 1 is excluded and the battery frame and the battery module are coupled.

FIG. 6 is a cross-sectional view taken along line VI in FIG. 5.

FIG. 7 is a cross-sectional view taken along line VII in FIG. 5.

FIG. 8 is a bottom plan view of the vehicle in FIG. 1 in which the battery pack is excluded.

FIG. 9 is a view illustrating a rear extension part and a leaf spring mounting bracket in FIG. 8 when viewed in direction IX.

FIG. 10 is a view for explaining, by using a cross-section in FIG. 3, an operation of the electric vehicle structure according to embodiments of the present invention in the event of a broadside collision accident of a vehicle.

### DETAILED DESCRIPTION OF ILLUSTRATIVE EMBODIMENTS

Hereinafter, embodiments disclosed in the present specification will be described in detail with reference to the accompanying drawings. The same or similar constituent elements are assigned with the same reference numerals throughout the figures, and the repetitive description thereof will be omitted.

The suffixes “module”, “unit”, “part”, and “portion” used to describe constituent elements in the following description are used together or interchangeably in order to facilitate the description, but the suffixes themselves do not have distinguishable meanings or functions.

In the description of the embodiments disclosed in the present specification, the specific descriptions of publicly known related technologies will be omitted when it is determined that the specific descriptions may obscure the subject matter of the embodiments disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and it includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described with different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

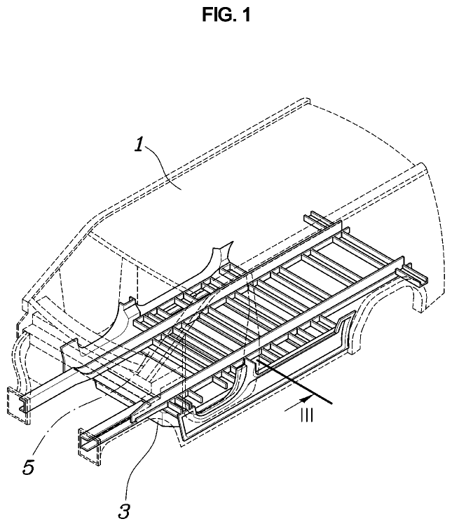

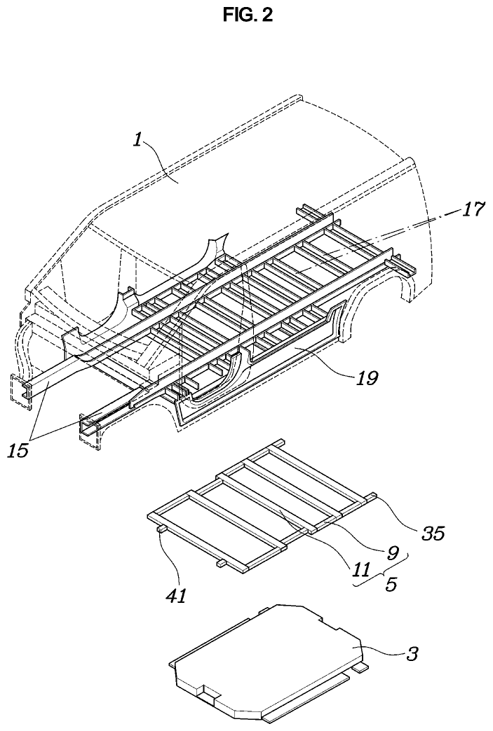

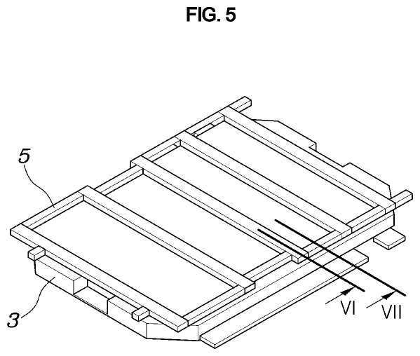

With reference to FIGS. 1 to 10, an electric vehicle structure according to embodiments of the present invention includes a vehicle body 1, a battery pack 3 mounted at a lower side of the vehicle body 1, and a battery frame 5 interposed between the vehicle body and the battery pack 3 and configured to protect a front side, a rear side, and two opposite lateral sides of the battery pack 3.

That is, in the electric vehicle structure of embodiments of the present invention, the battery pack 3 is mounted at the lower side of the vehicle body 1, and the separate battery frame 5 is provided between the vehicle body 1 and the battery pack 3 to protect the battery pack 3. Therefore, it is possible to effectively protect battery modules 7 accommodated in the battery pack 3 in the direction of various types of collision accidents of the vehicle.

The battery frame 5 is provided in the form of a lattice made by coupling a plurality of longitudinal members 9 and a plurality of transverse members 11.

That is, as illustrated, the battery frame 5 is positioned above the battery pack 3 and sized and shaped to surround substantially an entire outer periphery of an upper surface of the battery pack 3. The longitudinal member 9 or the transverse member 11 is at least positioned relatively outward from the battery modules 7 accommodated in the battery pack 3 on a horizontal plane. Therefore, in a case that an impact is applied from the outside through the front side, the rear side, and the two opposite lateral sides of the battery pack 3, the battery frame 5 supports the impact and effectively protects the battery modules 7 in the battery pack 3.

Meanwhile, the vehicle body 1 includes a floor panel 13, vehicle body side members 15 provided at two opposite sides of the vehicle body 1, elongated in a longitudinal direction of the vehicle body 1, and coupled to a lower surface of the floor panel 13, vehicle body cross members 17 configured to connect the vehicle body side members 15 at the two opposite sides, elongated in a transverse direction of the vehicle body, and coupled to the lower surface of the floor panel 13, and side sills 19 disposed below the floor panel 13 and provided at the two opposite sides of the vehicle body.

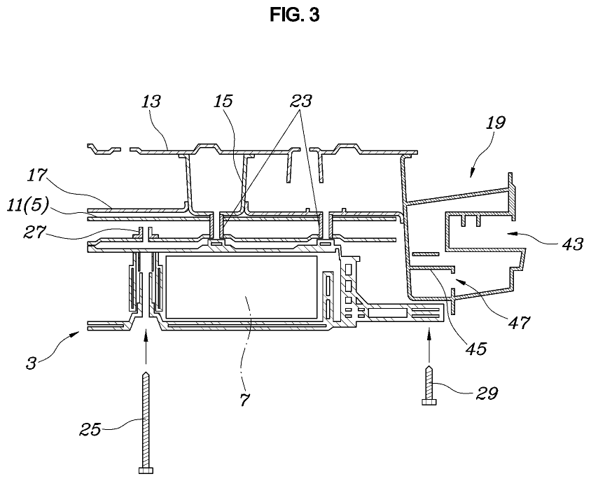

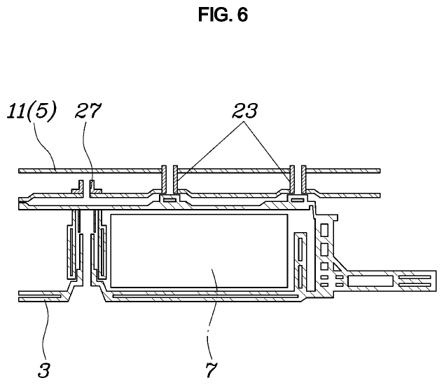

As illustrated in FIGS. 3 and 6, two opposite ends of the transverse member 11 of the battery frame 5 protrude further outward based on the vehicle body than the battery module 7 accommodated in the battery pack 3 and are positioned adjacent to the side sills 19. The longitudinal members 9 of the battery frame 5 are configured to connect the transverse members 11 in the longitudinal direction at positions adjacent to the side sills 19.

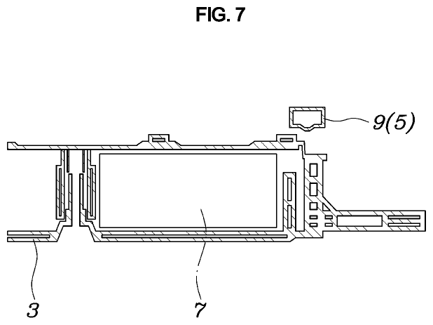

In addition, as illustrated in FIG. 7, the plurality of longitudinal members 9 of the battery frame 5 is positioned outward of the battery module 7 in the battery pack 3 based on the vehicle body and connects the transverse members 11 in the longitudinal direction.

The transverse members 11 of the battery frame 5 are installed to overlap the vehicle body cross members 17 in an upward/downward direction. A plurality of through pipes 23 is provided in the transverse members 11 so that frame mounting bolts 21, which penetrate the transverse members 11, pass through the through pipes 23.

In the present embodiment, the through pipes 23 include the through pipes 23 positioned below the vehicle body side member 15 and the through pipes 23 positioned outward of the battery module 7 of the battery pack 3 based on the vehicle body.

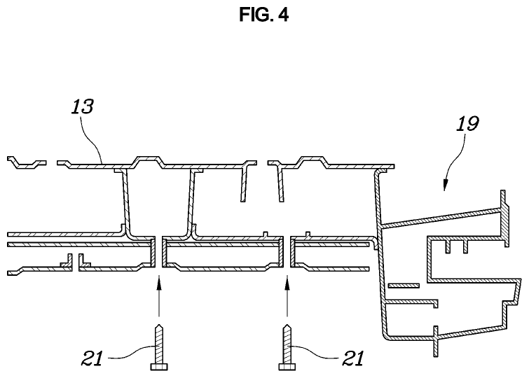

Therefore, as illustrated in FIG. 4, the frame mounting bolts 21, which penetrate the through pipes 23, are coupled to the vehicle body cross members 17 and the vehicle body side members 15, such that the battery frame 5 is coupled to the vehicle body 1.

Meanwhile, a plurality of mounting nuts 27 is provided in the transverse members 11 of the battery frame 5, and battery mounting bolts 25 for mounting the battery pack 3 are fastened to the mounting nuts 27.

Therefore, when the battery mounting bolts 25 penetrate the battery pack 3 and are coupled to the battery frame 5 coupled to the lower side of the vehicle body as described above, the battery pack 3 is mounted at the lower side of the vehicle body 1.

In addition, a casing side portion of the battery pack 3 may be coupled to lower sides of the side sills 19 of the vehicle body 1 by means of side mounting bolts 29, thereby ensuring a more secure mounted state of the battery pack 3.

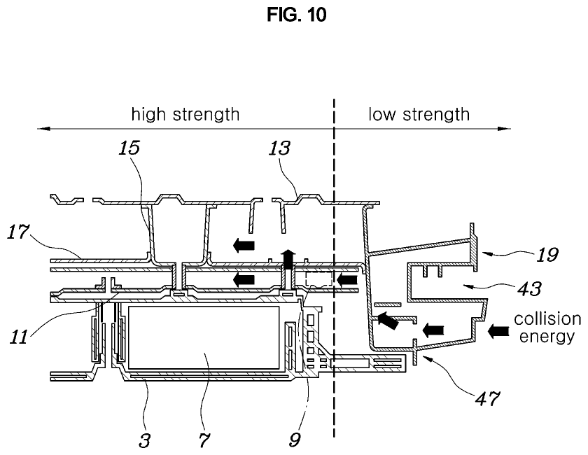

As described above, as illustrated in FIG. 10, in the event of a broadside collision accident or the like of the vehicle, in the structure in which the battery pack 3 is mounted at the lower side of the vehicle body 1 using the battery frame 5, collision energy inputted from a lateral side of the vehicle is transmitted through the battery frame 5 from the side sills 19 and supported by being dispersed to the vehicle body cross members 17 and the vehicle body side members 15 through the frame mounting bolts 21, thereby effectively preventing damage to the battery module 7 in the battery pack 3.

In particular, in the above-mentioned structure, based on the longitudinal members 9 of the battery frame 5, the outer portion of the vehicle body 1 has a relatively low strength, and the inner portion of the vehicle body 1 has a relatively high strength. Therefore, when collision energy is inputted to the lateral side of the vehicle, the outer portion of the longitudinal member 9 serves to absorb the collision energy while being deformed, and the inner portion of the longitudinal member 9 serves to disperse, absorb, and support the collision energy, thereby effectively protecting the battery module 7 in the battery pack 3.

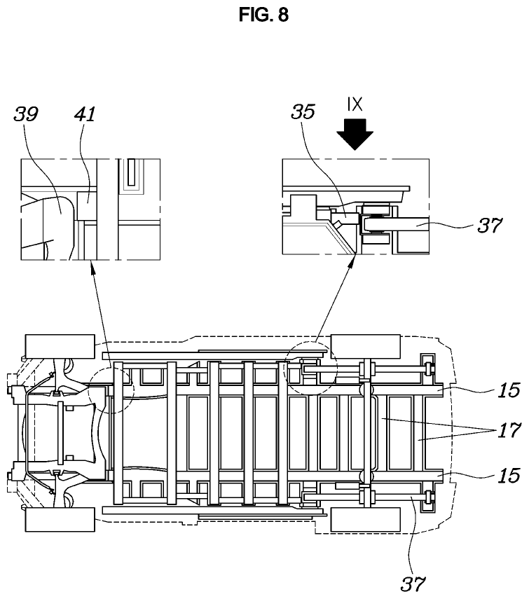

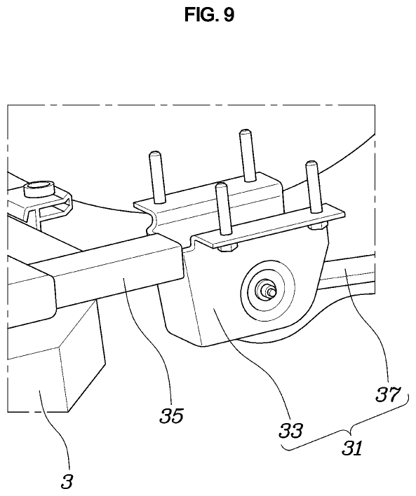

Meanwhile, with reference to FIGS. 8 and 9, a leaf spring-type suspension system 31 may be provided at a rear side of the vehicle body 1, and rear extension parts 35 may be provided at a rear side of the battery frame 5 and extend to a front end of a leaf spring mounting bracket 33.

In the present embodiment, the rear extension part 35 is provided at a rear side of the longitudinal member 9 of the battery frame 5 and elongated in a forward/rearward direction so as to define a straight line together with the longitudinal member 9.

Therefore, when a leaf spring 37 moves forward in the event of a rear collision accident or the like of the vehicle, the rear extension parts 35 of the battery frame 5 may suppress the forward movement of the leaf spring 37, thereby preventing damage to the battery pack 3 caused by the leaf spring 37.

In addition, front extension parts 41 may be provided at a front side of the battery frame 5 and protrude forward to support a rear side of a sub-frame 39 disposed at a front side of the vehicle.

In this case, in a situation in which the sub-frame 39 is about to move rearward and strike the battery pack 3 in the event of a frontal collision accident or the like of the vehicle, the front extension parts 41 of the battery frame 5 may suppress the rearward movement of the sub-frame 39, thereby preventing damage to the battery pack 3 caused by the sub-frame 39.

Meanwhile, a sliding rail part 43 may be provided on the side sill 19 and configured to guide a sliding door. A strength reinforcement part 47 including a reinforcing material 45 may be provided at a lower side of the sliding rail part 43.

Therefore, the strength reinforcement part 47 may suppress the deformation of the side sill 19 against an external impact and protect the sliding rail part 43, thereby ensuring the stable operability of the sliding door. The strength reinforcement part 47 serves to transfer collision energy to the battery frame 5, thereby preventing the external impact from being transmitted directly to the battery pack 3 disposed inside the side sills 19.

While the specific embodiments of the present invention have been illustrated and described, it will be obvious to those skilled in the art that the embodiments of the present invention may be variously modified and changed without departing from the technical spirit of the present invention defined in the appended claims.

What is claimed is:

1. An electric vehicle structure comprising:
a vehicle body;
a battery pack mounted at a lower side of the vehicle body; and
a battery frame interposed between the vehicle body and the battery pack and configured to protect a front side, a rear side, and two opposite lateral sides of the battery pack.

2. The electric vehicle structure of claim 1, wherein the battery frame has a lattice structure defined by coupling a plurality of longitudinal members and a plurality of transverse members.

3. The electric vehicle structure of claim 2, wherein the vehicle body comprises:
a floor panel;
vehicle body side members disposed at two opposite sides of the vehicle body, elongated in a longitudinal direction of the vehicle body, and coupled to a lower surface of the floor panel;
vehicle body cross members connecting the vehicle body side members at the two opposite sides, elongated in a transverse direction of the vehicle body, and coupled to the lower surface of the floor panel; and
side sills disposed below the floor panel at the two opposite sides of the vehicle body.

4. The electric vehicle structure of claim 3, wherein two opposite ends of the transverse members of the battery frame protrude further outward based on the vehicle body than a battery module accommodated in the battery pack and are positioned adjacent to the side sills, and the longitudinal members of the battery frame connect the transverse members in the longitudinal direction at positions adjacent to the side sills.

5. The electric vehicle structure of claim 4, wherein the longitudinal members of the battery frame are positioned outward of the battery module in the battery pack based on the vehicle body and connect the transverse members in the longitudinal direction.

6. The electric vehicle structure of claim 5, further comprising:
a leaf spring-type suspension system disposed at a rear side of the vehicle body; and
a rear extension part disposed at a rear side of the battery frame and extending to a front end of a leaf spring mounting bracket.

7. The electric vehicle structure of claim 6, wherein the rear extension part is disposed at a rear side of a longitudinal member of the plurality of longitudinal members of the battery frame and elongated in a forward/rearward direction so as to define a straight line together with the longitudinal member.

8. The electric vehicle structure of claim 5, further comprising a front extension part disposed at a front side of the battery frame and protruding forward, wherein the front extension part is configured to support a rear side of a sub-frame disposed at a front side of a vehicle.

9. The electric vehicle structure of claim 5, further comprising:
a sliding rail part disposed on one of the side sills, wherein the sliding rail part is configured to guide a sliding door; and
a strength reinforcement part including a reinforcing material disposed at a lower side of the sliding rail part.

10. An electric vehicle structure comprising:
a vehicle body comprising:
a floor panel;
vehicle body side members disposed at two opposite sides of the vehicle body, elongated in a longitudinal direction of the vehicle body, and coupled to a lower surface of the floor panel;
vehicle body cross members connecting the vehicle body side members at the two opposite sides, elongated in a transverse direction of the vehicle body, and coupled to the lower surface of the floor panel; and
side sills disposed below the floor panel at the two opposite sides of the vehicle body;
a battery pack mounted at a lower side of the vehicle body; and
a battery frame interposed between the vehicle body and the battery pack and configured to protect a front side, a rear side, and two opposite lateral sides of the battery pack, wherein the battery frame has a lattice structure defined by coupling a plurality of longitudinal members and a plurality of transverse members, wherein the transverse members of the battery frame overlap the vehicle body cross members in an upward/downward direction, wherein two opposite ends of the transverse members of the battery frame protrude further outward based on the vehicle body than a battery module accommodated in the battery pack and are positioned adjacent to the side sills, and wherein the longitudinal members of the battery frame are positioned outward of the battery module in the battery pack based on the vehicle body and connect the transverse members in the longitudinal direction at positions adjacent to the side sills.

11. The electric vehicle structure of claim 10, further comprising:
a plurality of through pipes disposed in the transverse members; and
frame mounting bolts that penetrate the transverse members and pass through the through pipes.

12. The electric vehicle structure of claim 11, wherein the plurality of through pipes comprises a first through pipe positioned below one of the vehicle body side members and a second through pipe positioned outward of the battery module of the battery pack based on the vehicle body.

13. The electric vehicle structure of claim 11, further comprising:
a plurality of mounting nuts disposed in the transverse members of the battery frame; and
a plurality of battery mounting bolts fastened to the mounting nuts to mount the battery pack.

14. A vehicle comprising:
a vehicle body;
a battery pack mounted at a lower side of the vehicle body; and
a battery frame interposed between the vehicle body and the battery pack and having a lattice structure defined by coupling a plurality of longitudinal members and a plurality of transverse members, wherein two opposite ends of the transverse members protrude further outward based on the vehicle body than the battery pack, and wherein the longitudinal members of the battery frame are positioned outward of the battery pack based on the vehicle body and connect the transverse members.

15. The vehicle of claim 14, wherein the vehicle body comprises:
a floor panel;
vehicle body side members disposed at two opposite sides of the floor panel and coupled to a lower surface of the floor panel;
vehicle body cross members connecting the vehicle body side members at the two opposite sides and coupled to the lower surface of the floor panel; and
side sills disposed below the floor panel at the two opposite sides of the floor panel, wherein the battery pack is positioned adjacent to the side sills.

16. The vehicle of claim 15, wherein the two opposite ends of the transverse members of the battery frame are positioned adjacent to the side sills, and wherein the longitudinal members of the battery frame connect the transverse members at positions adjacent to the side sills.

17. The vehicle of claim 14, further comprising a plurality of through pipes disposed in the transverse members.

18. The vehicle of claim 14, further comprising:
a leaf spring-type suspension system disposed at a rear side of the vehicle body; and
a rear extension part disposed at a rear side of the battery frame and extending to a front end of a leaf spring mounting bracket.

19. The vehicle of claim 18, wherein the rear extension part is disposed at a rear side of a longitudinal member of the plurality of longitudinal members of the battery frame and elongated in a forward/rearward direction so as to define a straight line together with the longitudinal member.

20. The vehicle of claim 14, further comprising a front extension part disposed at a front side of the battery frame and protruding forward, wherein the front extension part is configured to support a rear side of a sub-frame of the vehicle body disposed at a front side of the vehicle.
